(19) United States
(12) Patent Application Publication
(10) Pub. No.: US 2015/0118571 A1
(43) Pub. Date: Apr. 30, 2015

(54) FLUORINE-CONTAINING LITHIUM-GARNET-TYPE OXIDE CERAMICS

(71) Applicant: CORNING INCORPORATED, Corning, NY (US)

(72) Inventors: Cai Liu, Xinjiang County (CN); Zhaoyin Wen, Shanghai (CN)

(73) Assignee: SHANGHAI INSTITUTE OF CERAMICS, CHINESE ACADAMY OF SCIENCES, Shanghai (CN)

(21) Appl. No.: 14/517,089

(22) Filed: Oct. 17, 2014

(30) Foreign Application Priority Data
Oct. 31, 2013 (CN) 201310533064.3

(51) Int. Cl. H01M 10/0562; C04B 35/64

(52) U.S. Cl. CPC H01M 10/0562; C04B 35/64; H01M 2300/0071
USPC 429/319; 264/618; 429/322

(57) ABSTRACT

A lithium lanthanum zirconium oxide (LLZO) having a garnet crystal structure contains fluorine in an amount up to 40 mol %. The fluorine, which may be in the form of a lithium compound such as lithium fluoride, may act as a sintering aid and promote formation of the cubic garnet phase. The sintered oxide may be a dense ceramic that includes a plurality of distributed closed pores. Solid electrolyte membranes comprising the oxide can have an ionic conductivity of at least 1×10⁻⁴ S/cm.

This application claims the benefit of priority under 35 U.S.C. §119 of Chinese Patent Application Serial No. 201310533064.3 filed on Oct. 31, 2013 the content of which is relied upon and incorporated herein by reference in its entirety.

### BACKGROUND

1. Field

The present disclosure relates generally to ion-conductive ceramics, and more specifically to lithium-garnet-type oxides that contain fluorine and their methods of production.

2. Technical Background

Solid electrolytes, also known as fast ion conductors, can be used in energy storage devices such as solid oxide fuel cells and lithium-ion batteries. The solid electrolyte permits movement of ions without the need for a liquid or soft membrane separating the electrodes. In a lithium-ion battery, for example, lithium ions move from a negative electrode to a positive electrode during discharge (and back when charging) via the solid electrolyte. The solid electrolyte can conduct lithium ions through different mechanisms such as vacancies in the electrolyte crystal lattice. The solid electrolyte can also provide a hermetic barrier between the anode and the cathode in order to prevent the anode and cathode from short circuiting.

Important to the development of Li-ion batteries is the availability of dense, solid, lithium ion-conductive electrolyte membranes. A challenge in the formation of such membranes via traditional ceramic routes is the inability to sinter suitable starting materials to sufficient density to form a membrane that is hermetic while providing the requisite conductivity and economy.

In view of the foregoing, it would be desirable to develop an economical process for forming solid, lithium ion-conductive membranes.

### BRIEF SUMMARY

In accordance with various embodiments, disclosed are anion-doped lithium garnet-type oxides. Example lithium-containing oxides have a cubic garnet crystal structure and contain up to 40 mole % fluorine.

A method of forming a lithium-containing oxide comprises forming a mixture of precursor compounds, calcining the mixture at a first calcination temperature, calcining the mixture at a second calcination temperature greater than the first calcination temperature, compacting the mixture, and sintering the compact at a sintering temperature, wherein the oxide has a garnet crystal structure and contains up to 40 mole percent fluorine. The precursor compounds can include one or more fluorine salts as a source of fluorine. Example salts include LiF, NaF, KF, MgF₂, CaF₂ and BaF₂.

Additional features and advantages of the subject matter of the present disclosure will be set forth in the detailed description which follows, and in part will be readily apparent to those skilled in the art from that description or recognized by practicing the subject matter of the present disclosure as described herein, including the detailed description which follows, the claims, as well as the appended drawings.

It is to be understood that both the foregoing general description and the following detailed description present embodiments of the subject matter of the present disclosure, and are intended to provide an overview or framework for understanding the nature and character of the subject matter of the present disclosure as it is claimed. The accompanying drawings are included to provide a further understanding of the subject matter of the present disclosure, and are incorporated into and constitute a part of this specification. The drawings illustrate various embodiments of the subject matter of the present disclosure and together with the description serve to explain the principles and operations of the subject matter of the present disclosure. Additionally, the drawings and descriptions are meant to be merely illustrative, and are not intended to limit the scope of the claims in any manner.

### BRIEF DESCRIPTION OF THE DRAWINGS

The following detailed description of specific embodiments of the present disclosure can be best understood when read in conjunction with the following drawings, where like structure is indicated with like reference numerals and in which:

FIG. 1 shows x-ray diffraction spectra for examples 1-5;

FIG. 2 shows x-ray diffraction spectra for examples 1, 3 and 6;

FIG. 3 is a plot of room temperature AC impedance for examples 2 and 3;

FIG. 4 is an Arrhenius plot for example 3;

FIG. 5 shows cross-sectional SEM micrographs for examples 2, 3 and 7; and

FIG. 6 is a modeled schematic of the microstructure for lithium garnet-type oxide ceramics according to embodiments.

### DETAILED DESCRIPTION

Reference will now be made in greater detail to various embodiments of the subject matter of the present disclosure, some embodiments of which are illustrated in the accompanying drawings. The same reference numerals will be used throughout the drawings to refer to the same or similar parts.

Disclosed are lithium garnet-type oxide ceramics. The ceramics may be represented generally by the formula Li₇La₃Zr₂O₁₂ with z mol % F, where 0<z<40. The incorporation of fluorine may act as a sintering aid and promotes the formation of the cubic garnet phase. The cubic phase has an ionic conductivity as much as two orders of magnitude greater than the ionic conductivity of the tetragonal garnet phase. Fluorine may be added in the form of a fluoride salt such as LiF, NaF, KF, MgF₂, CaF₂ and BaF₂.

The lithium garnet-type oxide ceramics exhibit a unique microstructure due to anion (fluorine) doping. The addition of up to 40 mol % fluorine promotes the formation of a network of closed pores in the sintered ceramic. Closed porosity (as opposed to open, interconnected pores) contributes to a higher ionic conductivity and achievable hermeticity in solid membranes made using the disclosed ceramics. Applicants have determined that fluorine in an amount greater than 40 mol % may result in the undesired formation of La₂Zr₂O₇ as a second phase.

The average pore size in example sintered ceramics may range from 1 to 80 microns, e.g., 1, 2, 4, 10, 20, 40, 60 or 80 microns, such as 2 to 10 microns, or 10 to 60 microns. A total pore volume may range from 0 vol. % to 50 vol. %, e.g., 0, 2, 5, 10, 20, 30, 40 or 50 vol. %.

Applicants have also surprising discovered that grain boundaries are not observed in the sintered ceramics. The absence of grain boundaries will beneficially inhibit dendrite formation and improve the resistance of the ceramic to chemical etching especially by polar (e.g., liquid electrolyte) solutions.

In addition to anion (fluorine) doping, the disclosed oxide ceramics may optionally comprise one or more cation (M) dopants. Example cation dopants include Al, Ga, In, Si, Ge, Sn, Sb, Bi, Sc, Y, Ti, Hf, V, Nb and Ta, though other metal dopants may be used, which may be incorporated into the crystal lattice onto one or more of a Li site, a La site, or a Zr site. In addition to or in lieu of incorporation of a cation dopant onto a lattice site, such a dopant may be incorporated into the ceramic as a second phase.

A multi-step process may be used to form the lithium garnet-type oxide ceramics. The method generally involves mixing of precursor materials, calcination of the mixture, and consolidation and sintering to form a ceramic product.

The precursor materials may be powder materials. An average particle size of one or more of the precursor materials may be less than 100 microns, e.g., less than 50 or 10 microns.

As used herein, calcination or calcining refers to a thermal treatment, which may be conducted in air (or in the presence of oxygen), Ar or N₂, for example. Calcination of a solid material may induce one or more of thermal decomposition, phase transformation or removal from the solid of a volatile component. Calcination normally takes place at a temperature below the melting point of the reference material, but at or above the thermal decomposition temperature (for decomposition and volatilization reactions) or the transition temperature (for phase transitions).

Also, as used herein, sinter or sintering refer to a thermal process of densifying powder or particulate materials. The driving force in sintering is a decrease in surface energy. As the sintering of a crystalline material proceeds, adjacent particles coalesce owing to diffusion processes and consequently decrease the total surface area of the material.

In embodiments, suitable precursor materials include a lithium compound, a fluoride compound, and other inorganic materials. The inorganic materials can include carbonates, sulfates, nitrates, oxalates, chlorides, fluorides, hydroxides, organic alkoxides, and/or oxides of the elements to be included in the ceramic.

The precursor materials may be pre-treated. A lanthanum oxide precursor, for example, may be pre-heated to 900° C. prior to mixing the lanthanum oxide with other precursor material in order to remove residual hydroxide or carbonate.

In a mixing step, a selected amount (e.g., a stoichiometric amount) of the precursor materials are combined and milled into fine powder. The mixing can include dry milling, or wet milling with a suitable solvent that does not dissolve the inorganic materials. Example milling processes may use a planetary mill, ball mill, jet mill, and the like. As a result a milling step, the average particle size of the mixture can be reduced to less than 10 microns, e.g., about 2, 5 or 10 microns.

The prepared mixture is calcined in a first calcination step. In this step, the mixture is heated at a temperature that is greater than or equal to a pretreatment temperature, but less than a second calcination temperature. Carbonate and hydroxide precursor materials, if used, will decompose during the first calcination step. For example, a decomposition temperature for Li₂CO₃ is about 900° C. A temperature for the first calcination step may range from 600° C. to 1000° C.

After the first calcination step, the inorganic materials may be milled further to form a homogeneous composition. The mixture is then calcined in a second calcination step. A temperature for the second calcination step may range from 900° C. to 1200° C. As a result of the second calcination step, the inorganic materials react to form the garnet phase(s).

The reaction products of the second calcination step may be milled to a fine powder, compacted, and sintered to form dense ceramic pellets. The compact can be formed into arbitrary shapes by cold or hot pressing, or other forming methods known in the art. In embodiments, during the sintering process the compact is partially or wholly encapsulated by the mother powder to inhibit the loss of volatile components (e.g., lithium). In related embodiments, a powder composition used to encapsulate the compact may differ from the compact composition only with respect to the lithium content in each.

The lithium garnet-type oxide ceramics may be used in a solid electrolyte. As solid electrolytes, the disclosed materials may exhibit one or more beneficial properties such as high ionic conductivity, negligible electronic conductivity, high mechanical strength, and low grain boundary resistance. An ionic conductivity of an example garnet-type lithium-containing oxide is greater than or equal to 1×10⁻⁴ S/cm. The disclosed ceramic materials may be electrochemically stable, non-hygroscopic and characterized by a wide electrochemical window, low toxicity, and low cost fabrication.

Solid electrolytes comprising a lithium garnet-type oxide ceramic can be incorporated into lithium ion batteries or lithium metal based batteries such as lithium-air or lithium-sulfur cells.

### EXAMPLES

### Example 1-5

Garnet-type lithium lanthanum zirconium oxides (LLZOs) represented by the formula Li₇La₃Zr₂O₁₂—z mol % LiF, where z is equal to 0, 14, 24, 40, or 62, were prepared from inorganic starting materials.

The starting materials included Li₂CO₃, La₂O₃, ZrO₂, and LiF as respective sources of Li, La, Zr and F. The La₂O₃ was heated at 900° C. for 12h before weighing.

With the exception of Li₂CO₃, which was included at a 10 wt. % excess to compensate for the loss of lithium during the sintering process, the starting materials were mixed at the stoichiometric ratio using a wet (ethanol) grinding process in a planetary ball mill with zirconia balls as the milling media. The ball mill was run at 250 rpm for 12 h.

The mixtures were dried to remove the ethanol, calcined in an alumina crucible at 900° C. in air for 12 h, and then cooled down to 25° C.

After the first calcination step, the ball-milling and drying process was repeated to form a homogeneous fine powder.

The powder was calcined in a second calcination step in alumina crucibles at 1125° C. in air for 12 h.

After the second calcination step, the ball-milling and drying process was repeated.

The resulting powders were pressed into green disks that were sintered to form dense ceramic bodies. Pressing involved first consolidating the respective powder samples at 4 MPa to form 12 mm diameter green disks, which were subsequently compacted using a cold isostatic press at 250 MPa to from compacted green bodies.

During sintering at 1230° C. for 36 h in a platinum crucible, the compacted green bodies were encapsulated with un-compacted powder of a corresponding composition.

### Example 6

A garnet-type oxide represented by the formula Li₇La₃Zr₂O₁₂—12 mol % CaF₂ was prepared in accordance with the procedures described above, but using CaF₂ in place of LiF. The mole percent of fluorine in Example 6 is equal to the mole percent of fluorine in Example 3.

### Example 7

A cation-doped garnet-type oxide represented by the formula Li_{6.75}La₃Zr_{1.75}Nb_{0.25}O₁₂—24 mol % LiF was prepared in accordance with the procedures described above, except using a second calcinations step at 950° C.

Compositions and select properties of Examples 1-7 are summarized in Table 1. Examples 1, 4 and 5 are comparative (†).

TABLE 1
Example lithium garnet-type oxide ceramics

| | Composition | XRD | Conductivity |
|---|---|---|---|
| Ex. 1† | Li₇La₃Zr₂O₁₂ | tetragonal | <10⁻⁶ S/cm |
| | | LLZO | |
| Ex. 2 | Li₇La₃Zr₂O₁₂ - | cubic LLZO | 4.9 × 10⁻⁴ S/cm |
| | 14 mol % LiF | | |
| Ex. 3 | Li₇La₃Zr₂O₁₂ - | cubic LLZO | 5.2 × 10⁻⁴ S/cm |
| | 24 mol % LiF | | |
| Ex. 4† | Li₇La₃Zr₂O₁₂ - | cubic LLZO | |
| | 40 mol % LiF | and La₂Zr₂O₇ | |
| Ex. 5† | Li₇La₃Zr₂O₁₂ - | cubic LLZO | |
| | 62 mol % LiF | and La₂Zr₂O₇ | |
| Ex. 6 | Li₇La₃Zr₂O₁₂ - | cubic LLZO | |
| | 12 mol % CaF₂ | | |
| Ex. 7 | Li_{6.75}La₃Zr_{1.75}M_{0.25}O₁₂ | | |
| | (M = Nb) - 24 mol % LiF | | |

Powder x-ray diffraction (Rigaku Ultima IV, nickel-filtered Cu—Kα radiation, λ=1.542 Å, 10°≦2θ≦70°, 0.1°/sec scan rate) was used to determine the phase formation in the respective samples.

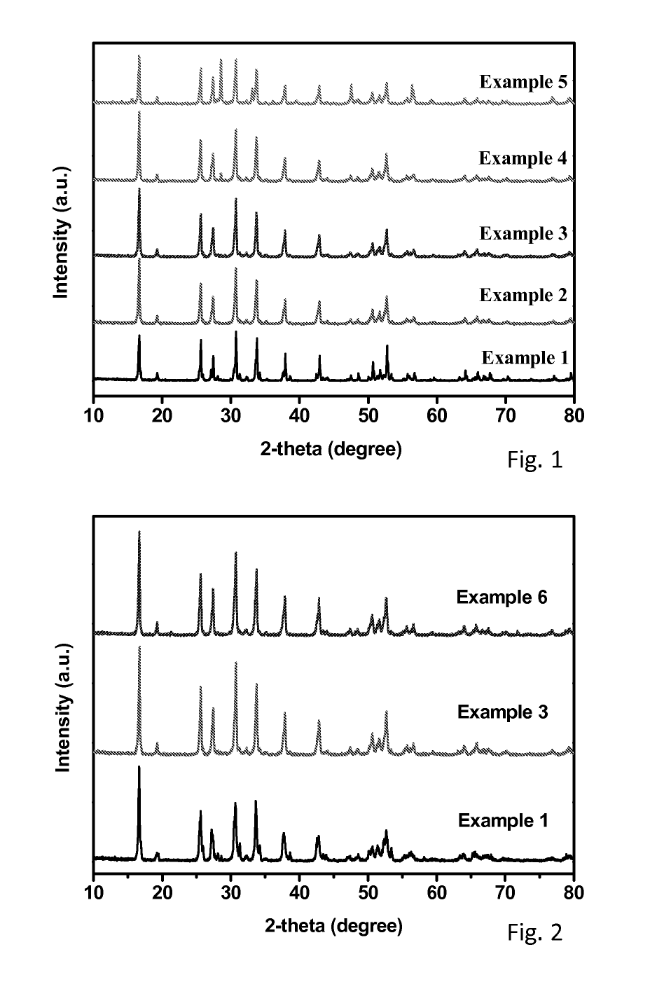

The XRD data are shown in FIGS. 1 and 2. The data in FIG. 1 correspond to samples after the second calcination step but prior to sintering, and the data in FIG. 2 correspond to samples with different fluorides.—After the second calcination, Example 1 exhibits reflections that index to a tetragonal garnet phase, while the reflections from examples 2 and 3 index to a cubic garnet phase. Present in the XRD patterns of comparative examples 4 and 5 is the impurity phase La₂Zr₂O₇.

Ionic conductivity was measured at room temperature using an Auto Lab Impedance analyzer (Model PGSTAT302N) over the frequency range 1 Hz to 1 MHz. Gold electrodes were sputter deposited onto opposing parallel surfaces of the ceramic pellets.

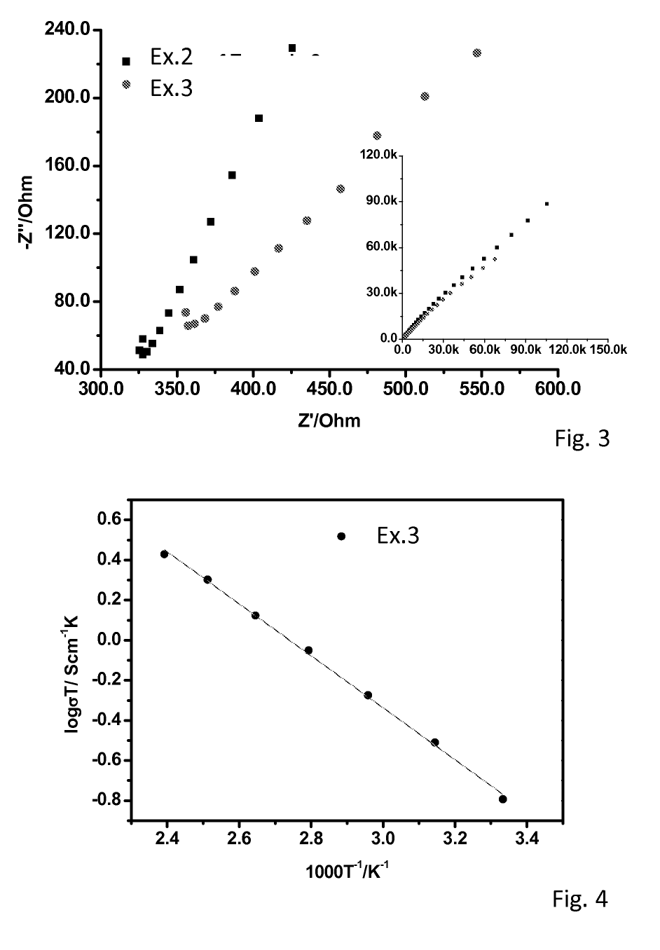

Impedance spectra for examples 2 and 3 are shown in FIG. 3. The inset plot shows data over the range 1 Hz to 1 MHz. The total conductivity for example 2 was 4.9×10⁻⁴S/cm and the total conductivity for example 3 was 5.2×10⁻⁴S/cm.

The activation energy (Ea) of the Li₇La₃Zr₂O₁₂—24 mol % LiF ceramic of example 3 was calculated from the Arrhenius plot of FIG. 4 using the equation σT=Aexp(Ea/kT), wherein σ represents the ionic conductivity, A is the frequency factor, Ea is the activation energy, k is the Boltzmann constant, and T is the absolute temperature. Temperature-dependent ionic conductivity data was collected over the range 300K to 418K. Based on a linear fit of the FIG. 4 data, the activation energy was calculated to be 0.26 eV, which is less than the activation energy for pure Li₇La₃Zr₂O₁₂.

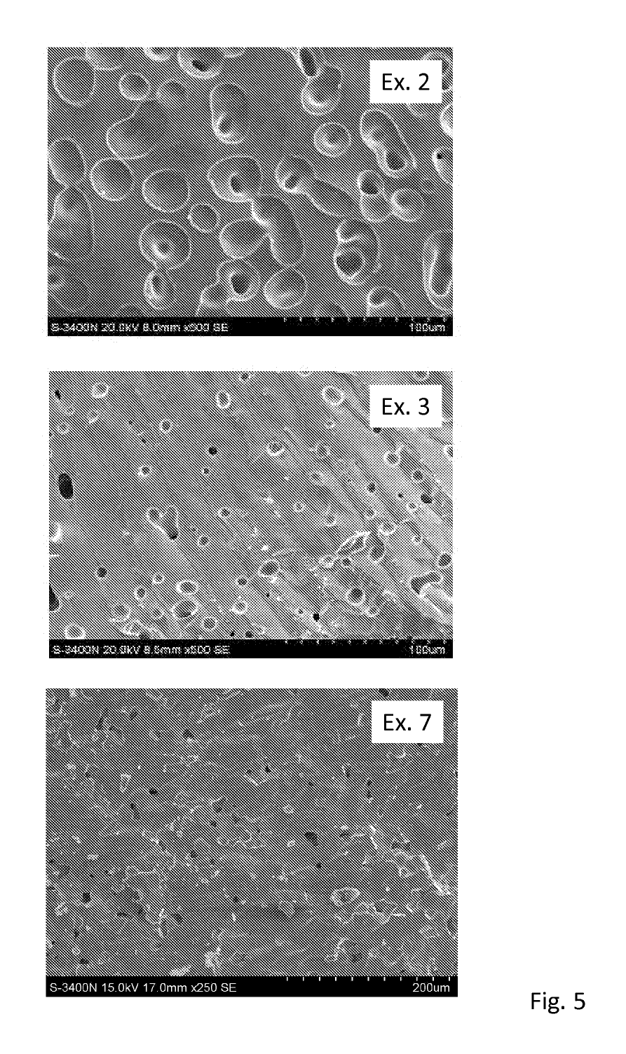

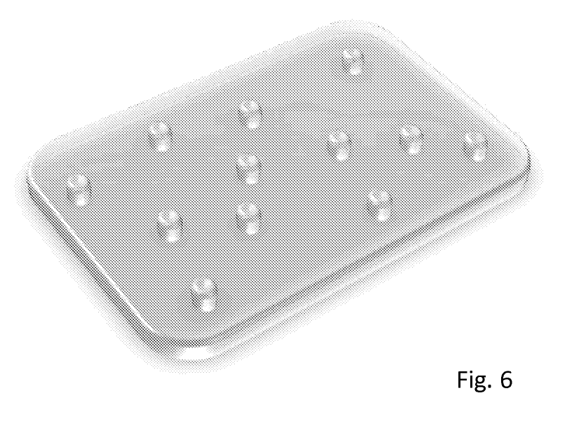

Cross-sectional SEM micrographs showing the microstructures of examples 2, 3 and 7 are presented in FIG. 5. The microstructure in each example includes a plurality of closed pores. Through the formation of a network of closed pores, solid electrolyte membranes made using the disclosed sintered ceramics may be hermetic. No evidence of grain boundaries was observed in the sintered samples.

As used herein, the singular forms “a,” “an” and “the” include plural referents unless the context clearly dictates otherwise. Thus, for example, reference to an “inorganic material” includes examples having two or more such “inorganic materials” unless the context clearly indicates otherwise.

Ranges can be expressed herein as from “about” one particular value, and/or to “about” another particular value. When such a range is expressed, examples include from the one particular value and/or to the other particular value. Similarly, when values are expressed as approximations, by use of the antecedent “about,” it will be understood that the particular value forms another aspect. It will be further understood that the endpoints of each of the ranges are significant both in relation to the other endpoint, and independently of the other endpoint.

Unless otherwise expressly stated, it is in no way intended that any method set forth herein be construed as requiring that its steps be performed in a specific order. Accordingly, where a method claim does not actually recite an order to be followed by its steps or it is not otherwise specifically stated in the claims or descriptions that the steps are to be limited to a specific order, it is no way intended that any particular order be inferred.

It is also noted that recitations herein refer to a component being “configured” or “adapted to” function in a particular way. In this respect, such a component is “configured” or “adapted to” embody a particular property, or function in a particular manner, where such recitations are structural recitations as opposed to recitations of intended use. More specifically, the references herein to the manner in which a component is “configured” or “adapted to” denotes an existing physical condition of the component and, as such, is to be taken as a definite recitation of the structural characteristics of the component.

While various features, elements or steps of particular embodiments may be disclosed using the transitional phrase “comprising,” it is to be understood that alternative embodiments, including those that may be described using the transitional phrases “consisting” or “consisting essentially of,” are implied. Thus, for example, implied alternative embodiments to a ceramic that comprises lithium, lanthanum, zirconium, fluorine and oxygen include embodiments where a ceramic consists lithium, lanthanum, zirconium, fluorine and oxygen and embodiments where a ceramic consists essentially of lithium, lanthanum, zirconium, fluorine and oxygen.

It will be apparent to those skilled in the art that various modifications and variations can be made to the present invention without departing from the spirit and scope of the invention. Since modifications, combinations, sub-combinations and variations of the disclosed embodiments incorporating the spirit and substance of the invention may occur to persons skilled in the art, the invention should be construed to include everything within the scope of the appended claims and their equivalents.

We claim:

1. A lithium-containing oxide comprising:
a garnet crystal structure; and
a fluorine content z, where 0<z<40 mol %.

2. The lithium-containing oxide according to claim 1, comprising a cubic garnet crystal structure.

3. The lithium-containing oxide according to claim 1, comprising at least 10 mol % fluorine.

4. The lithium-containing oxide according to claim 1, being substantially free of grain boundaries.

5. The lithium-containing oxide according to claim 1, furthering comprising at least one dopant selected from the group consisting of Al, Ga, In, Si, Ge, Sn, Sb, Bi, Sc, Y, Ti, Hf, V, Nb, and Ta.

6. The lithium-containing oxide according to claim 1, furthering comprising a cation dopant incorporated into the oxide as a second phase.

7. The lithium-containing oxide according to claim 1, having the formula Li₇La₃Zr₂O₁₂—z mol % F, where 0<z<40.

8. A solid membrane comprising the lithium-containing oxide according to claim 1.

9. The solid membrane according to claim 8, comprising a network of closed pores.

10. The solid membrane according to claim 8, having an ionic conductivity of at least 1×10⁻⁴ S/cm.

11. A method of forming a lithium-containing oxide comprising:
forming a mixture of precursor compounds;
calcining the mixture at a first calcination temperature;
calcining the mixture at a second calcination temperature greater than the first calcination temperature;
compacting the mixture; and
sintering the compact at a sintering temperature, wherein the oxide has a garnet crystal structure and contains fluorine in an amount up to 40 mole percent.

12. The method according to claim 11, wherein the precursor compounds are selected from the group consisting of LiF, NaF, KF, MgF₂, CaF₂ and BaF₂.

13. The method according to claim 11, wherein the precursor compounds further comprise Li₂CO₃, La₂O₃ and ZrO₂.

14. The method according to claim 11, comprising milling the mixture during at least one period selected from (a) before calcining the mixture at the first calcination temperature, (b) after calcining the mixture at the first calcination temperature but before calcining the mixture at the second calcination temperature, and (c) after calcining the mixture at the second calcination temperature but before sintering the mixture.

15. The method according to claim 11, wherein the first calcination temperature is from 600° C. to 1000° C.

16. The method according to claim 11, wherein the second calcination temperature is from 900° C. to 1200° C.

17. The method according to claim 11, wherein during the sintering the compact is at least partially encapsulated by a powder mixture having a composition equal to a composition of the mixture of precursor compounds.

18. The method according to claim 11, wherein the lithium-containing oxide comprises a cubic garnet crystal structure.

19. The method according to claim 11, wherein the lithium-containing oxide has the formula Li₇La₃Zr₂O₁₂—z mol % F, where 0<z<40.
